(19) United States
(12) Patent Application Publication
(10) Pub. No.: US 2013/0298020 A1
(43) Pub. Date: Nov. 7, 2013

(54) APPARATUS AND METHOD FOR HANDLING INTERACTIVE MEDIA CONTENT REQUESTS USING MULTIPLE MEDIA MANAGERS

(71) Applicant: George Stoikos, Serres (GR)

(72) Inventor: George Stoikos, Serres (GR)

(21) Appl. No.: 13/463,846

(22) Filed: May 4, 2012

(51) Int. Cl. G06F 3/01

(52) U.S. Cl. 715/716

(57) ABSTRACT

A media selection and playback system includes a master media manager controller disposed in communication with at least one location media server which is disposed communication with at least one audio-visual playback device. At least one or a plurality of virtual mobile media manager controllers are disposed in data communication with the master controller and are coupled to one or more location media server s, each of which communicates with one or more audio-visual devices. A user request is routed through the media manager controllers and the location media server s to determine which one can handle the user request to forward the media selected in the user request to the selected one of the audio-visual devices specified in the user request.

### BACKGROUND

The present invention relates, in general, to audio/visual content delivery and broadcast systems and, specifically, to the selection of specific content or media for output on a selected audio/visual device.

Audio/video media content selection and delivery systems come in many forms. Generally speaking, a user via a computer, mobile communication device, etc., can access a source of audio/video content, and then select the desired content for delivery to a specific audio/video device, such as a jukebox system in a bar or restaurant, a computer monitor, the user's mobile device, etc.

For example, a typical audio/video selection and delivery system as shown in Applicants' prior U.S. Pat. Nos. 7,647,613 and 7,797,719.

Applicants' system utilizes a central music server coupled to media content storage, such as music, videos and combinations thereof. A central mobile media manager server is interposed between a wireless communication system, such as the Internet receiving media requests from user devices, such as personal computers, tablet computers, mobile communication devices, such as cellular telephones, etc. and controls the management, selection and output of such selected media content through the central music server to an audio/video display device selected by the user.

The mobile media manager server communicates with a location media server at the display cite, such as digital jukebox, etc.

A location media server, at the bar or restaurant, controls the display of the selected media content on a selected one of one or more audio/video devices in the location, such as one or more display screen monitors in a bar or restaurant. The location media server, in conjunction with the mobile media management server, can also be employed to direct selected media content to one specific audio/video device from one user and other selected media content from other users to other audio/video devices in the same location.

However, Applicants' prior apparatus and method for interactive content requests is capable of supporting a limited number of audio/video units through a limited number of location media servers. It would be desirable to provide a method and apparatus for expanding Applicants' mobile media manager apparatus and method to support multiple audio/video units which may be located in the same or many different physical locations.

### SUMMARY

A method for digital content selection and play comprises the steps of receiving a user request by a master media manager controller (MMM) requesting a specific digital media for play on a specific audio-visual playback device, at least one virtual MMM residing in a computer readable medium of a computing device disposed in data communication with the master MMM, at least one location media server (LMS) in communication with the at least one virtual MMM, at least one audio-visual playback device in communication with the at least one LMS, accessing by the master MMM a store of media content, and transmitting the identified digital media by the master MMM through the at least one virtual MMM and the at least one location media server to the selected audio-visual device for play of the identified media by the selected audio-visual device.

A plurality of virtual MMMs may be provided in communication with the master MMM along with a plurality of location media server s, with at least one location media server coupled in communication with each virtual MMM, and at least one audio-visual device coupled in communication with each location media server.

The method may further comprise the step of disposing the plurality of virtual MMM's and the master MMM in communication with each other such that each one of the master MMM and each one of the virtual MMMs are able to access the digital media content store.

In one aspect, the plurality of virtual MMM and the master MMM are coupled in a mesh network with each other. In one aspect, each of the master MMM and the virtual MMMs are disposed for receiving a user request.

In one aspect, the one of the master MMM and the virtual MMMs that receives an incoming user request determines if the receiving MMM can service the user request. If yes, the receiving MMM determines the availability of one of the location media server s disposed in communication with the receiving MMM, and forwards the digital media selected in the user request to the selected location media server.

In the method, if the receiving MMM cannot service the incoming user request, the master MMM, or any other MMM if the master MMM cannot service the user request, ranks all of the available virtual MMMs in descending rank according to ranking parameters, forwards the incoming user request to the first ranked MMM, determines if the first ranked MMM can service the incoming user request and, if yes, the receiving MMM forwards the incoming user request media content to the first ranked MMM.

In the method, if the first ranked MMM cannot service the incoming user request, the first ranked MMM is removed from the top of the ranking, and receiving MMM forwards the incoming request to the next highest ranked MMM.

A streaming audio-video server can be coupled in communication with the media store, the master mobile media controller, and any of the virtual media manager controllers to convert a selected media in the content database to a streaming audio-video format, which is then transferred by the streaming audio-video server to the master MMM or directly to the virtual MMMs and then through the Internet to the specified local media controllers and A/V devices.

### BRIEF DESCRIPTION OF THE DRAWING

The various features, advantages and other uses of the present invention will become more apparent by referring to the following detailed description and drawing in which:

FIG. 1 is a block diagram of one aspect of an apparatus for handling interactive content requests;

FIG. 2 is a block diagram of the mobile media manager (MMM) and virtual mobile media network shown in FIG. 1;

FIG. 3 is a detailed block diagram of the apparatus shown in FIG. 1;

FIG. 4 is a detailed block diagram of the mobile media manager shown in FIG. 1;

FIG. 5 is a flow diagram depicting a method for interactive content request;

FIG. 6 is a block diagram of another aspect of an apparatus for handling interactive content requests; and

FIG. 7 is a block diagram of another aspect of the apparatus.

### DETAILED DESCRIPTION

An interactive media request system in a communication network is disclosed for selecting content, such as songs and/or videos, from user requests from a mobile communication device for output by an audio-visual playback device.

The term “audio-visual” as referred to herein to encompass audio data, such as music, spoken words, etc., visual data, such as movies, video games, and other visual images, including text, and combinations of audio and visual material simultaneously output to an audio-visual playback device. Thus, it will be understood that although music and music identification data are referred to hereafter, it will be understood that this is by way of example only.

Further, it will be understood that the use of the term digital media will encompass both audio and/or visual data as well as audio and/or visual data identification, such as author name, title, length of play, type of media, etc.

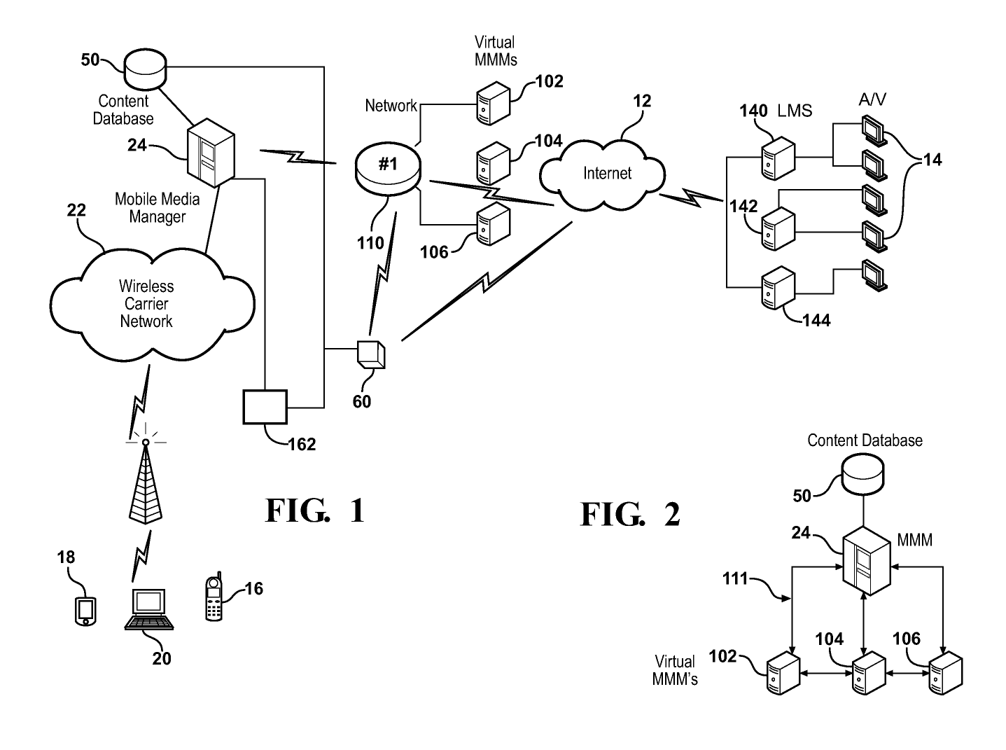

In one aspect shown in FIG. 1, a central management system manages a communication link to mobile stations in a media content network and translates packets in the payloads of SMS, MMS or Internet messages containing specific content selections created by a mobile user located remote from the playback devices. A central Mobile Media Manager (MMM) 24 implemented as a feature of communication link 22, such as a carrier network, which may be implemented as a Short-Message-Service-Center (SMSC) 22 and Mobile-Multimedia-Service-Environment (MMSE) or an Internet network, manages concurrent mobile-originating transmissions representing mobile user selected content or media, such as song selections, designated for broad case from one of a plurality of A/V devices.

At least a portion of the carrier network 22 may include wireless communication. The central MMM 24 addresses a media content database 50 via HTTP, for example, that maintains a master set of compressed digital data or media representing a plurality of songs, song associated graphics, song identity information, videos and audio/video (A/V) venue location identification codes, for example. The MMM 24 receives mobile selection information from the carrier network 22 and polls the database 50 to obtain an updated list of registered audio/visual devices 14, to determine content availability from a list of content or music residing on the database 50 and/or the A/V devices 14, and to check the validity of the user request.

Specific content selections initiated by a mobile user 16, 18, 20 including content event or song identity, venue location register and service priority queuing to a specific A/V device 14, received at the central MMM 24 to provide audio or video output in the service, venue or A/V device 14 where the mobile user initiated the selection. The MMM 24 interfacing the carrier network 22 and the A/V network operates on a scheduled peer session interval to authenticate users, determine the value of the billing event and handle submission of user requests. The MMM 24 differentiates the value of the network carrier requests to the billing entity. The MMM 24 communicates to the core network carrier 22 whether a mobile user, i.e., wireless carrier, SMSC, etc., should be billed only after the MMM 24 has verified that a corresponding A/V device 14 is operating, the MMM 24 has verified that the master or the subset of the master set of digital media is available, and the MMM 24 has forwarded the user request designated as a Standard or Priority request to be placed in the network 10 queue.

In FIG. 1, an A/V network 100 is illustrated, by example, as including a master mobile media manager controller (MMM) 24 having a host processor which communicates via HTTP or other data transmission formats through a wireless communication system, such as the Internet 12, hardline, etc., to at least one or a plurality of digital audio-visual playback devices 14, such as monitors, digital jukeboxes, mobile telephone and tablet computer display screens, smart televisions, etc. The communication format to each A/V device 14 can be via any transmission protocol, such as ADSL, cable modem, WCDMA, UMTS, or LMDS or other data communication protocols.

According to this aspect, a mobile communication device or user interface, typically a mobile wireless communication device, such as a cellular telephone 16, a PDA 18, or a computer 20, as non-limiting examples only, communicates with the communication network 22. The communication link or network 22 may be any type of communication provider either wireless or not, such as, but not limited to, WiFi, Internet, direct cable connection, Ethernet, GSM,GPRS, UMTS, Edge, Token ring etc. Such a network 22 may have as a subset, a Short Message Service Center (SMSC) adapted for short text messaging, an Internet protocol having displayable drop down menus allowing user input selections, or a multimedia service (MMS) providing audio and graphic data.

Although the following example of a wireless content request pertains to a short message service using an SMSC subset of the wireless carrier network 22, it will be understood that similar data input protocols or media selection, such as through drop down menus, may also be employed.

An appropriate SMS address, such as 1414 for example, is entered by the user through the communication device 16, 18, or 20 to identify the MMM 24 service. Text messages formed of UNICODE or ASCII characters are then input by a user through the user interface 16, 18, or 20 to identify the digital media selection and other related play features, such as premium play, immediate play, etc. For example, a text message of S AB123 can be input by a user through the communication device 16, 18 or 20. The first character, labels S, by example only, is the type of media content. By example only S identifies a song. V would identify a video. PS would identify a priority play of a selected song. PV would identify a priority play of a video. The characters AB identify the location of the local jukebox 14. The alphanumeric characters 123 identify a particular media selection, such as a particular song. This information is obtainable from a list provided to the user at the local jukebox 14 venue.

These signals are transmitted to the SMSC where the user ID is validated. The location of the A/V playback device 14, media selection, and play feature data are transmitted from the SMSC to the MMM 24 by hard wire and/or wireless communication or combinations of both. The MMM 24 receives the selection information from the SMSC and communicates with the database 50 to determine the availability of the selected content and the selected A/V devices 14. When the MMM 24 has verified the corresponding A/V device 14 is operating and available to play the selected digital media, the MMM 24 sends a signal to the SMSC to bill the user for the SMS message including any premium play billing. The SMSC may then request a third party, such as, but not limited to, a bank, a credit card company, a mobile operator, etc., to debit the user account for the amount of the services procured. Other methods of payment may include m-wallet (mobile wallet), prepaid cards etc.

The MMM 24 can also communicate directly with a bank, credit card company or mobile operator to perform billing procedures without directly contacting the SMSC.

The user's communication device, namely, the user's mobile telephone 16, PDA 18 or even the user's desktop or laptop computer 20 can be provided with an application (hereafter “app”) which replaces the functionality of the SMS message sent by the user to the MMM 24.

The user can open the app and then press or click a button in the app which corresponds to a selection of a song or video to play at a particular location. The app creates a message using established protocols, such as SOAP, xml over http, http posts, etc., that has the LMS code or ID in the song code, such as S AB 1234. The tcp-ip address of the MMM 24 is well known to the app. The app then forwards the message to the MMM 24 directly over the wireless communication link, such as the wireless Internet link using established transmission formats, such as 4G, lte, 3G Edge, GPRS, etc.

Upon receipt of the message from user's app, the MMM 24 creates a reply to the user which may contain text, images, etc., using the tcp-ip address of the user's mobile device to acknowledge receipt of the song selection, and other information as described above. The MMM 24 then forwards this reply to the user's app for viewing by the user.

At the same time, the MMM 24 sends the user request along with play criteria, such as a standard, recommendation or priority request, to a location media server (LMS) coupled to the selected A/V device 14. This communication is via the Internet 12 to the selected A/V device 14 to implement the digital media selection at any premium or standard schedule.

It will be noted that the transmission of the digital media selection signals from the MMM 24 to the LMS and the selected A/V device 14 can also include the entire selected digital media, or simply a signal to the A/V device 14 to play a particular digital media already stored in the memory of the selected A/V device 14 or its LMS.

The MMM 24 can also send only a signal to the LMS, such as LMS 140, 142, or 144, each coupled to one or more A/V devices 14, send a command to one of the LMSs 140, 142, or 144, with three shown by way of example only in Fig. 1, in the form of a command to one particular LMS, such as LMS, 140 to play the user selected digital media on one particular A/V device 14 coupled to the selected LMS 140, as well as identifying the location of the selected digital media. The location of the selected digital media can be in the content database 50. In this case, the MMM 24 extracts the complete selected digital media from the content database 50 which is then transferred through the MMM 24 and the Internet 12 to the selected LMS 140.

The LMS 140, 142 and 144 can each be embodied in a server which can be any suitable computing device having a central processor executing a control program stored in a memory, either formed as part of the LMS or separate from, but disposed in communication with the processor of the LMS.

As will become more apparent hereafter, each LMS 140, 142 and 144 has an A/V output 139 hardwired or coupled in wireless communication with the one or more A/V units 14 associated with a particular LMS, such as LMS 140. The A/V output 139 is capable of converting the digital content received from the content database 50 in accordance with the user selection to audio video signals which can be played by the A/V unit 14.

The MMM 24 is also capable of sending a message through the SMSC to the user 16 thanking the user for making the selection. This will confirm that the selection has been implemented. At the same time, the message to the user 16 can include other messages, such as an offer to buy the selected song or video at a particular price or the ability to purchase or download as wall paper to the user 16 pictures of the artist performing the selected song or performing in the selected video.

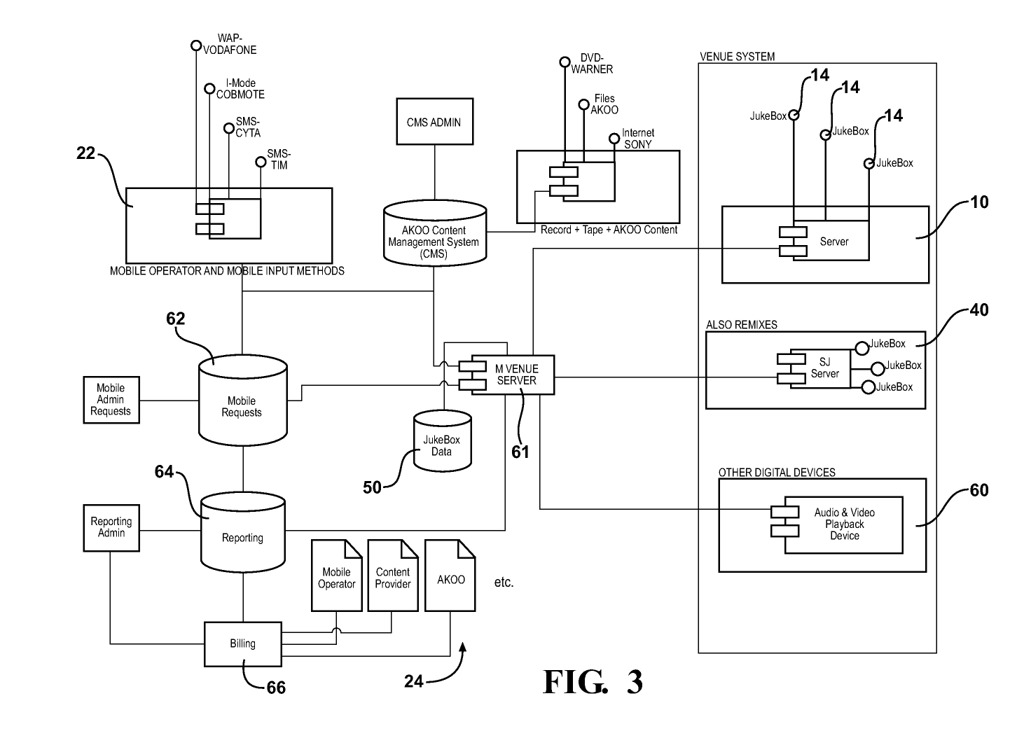

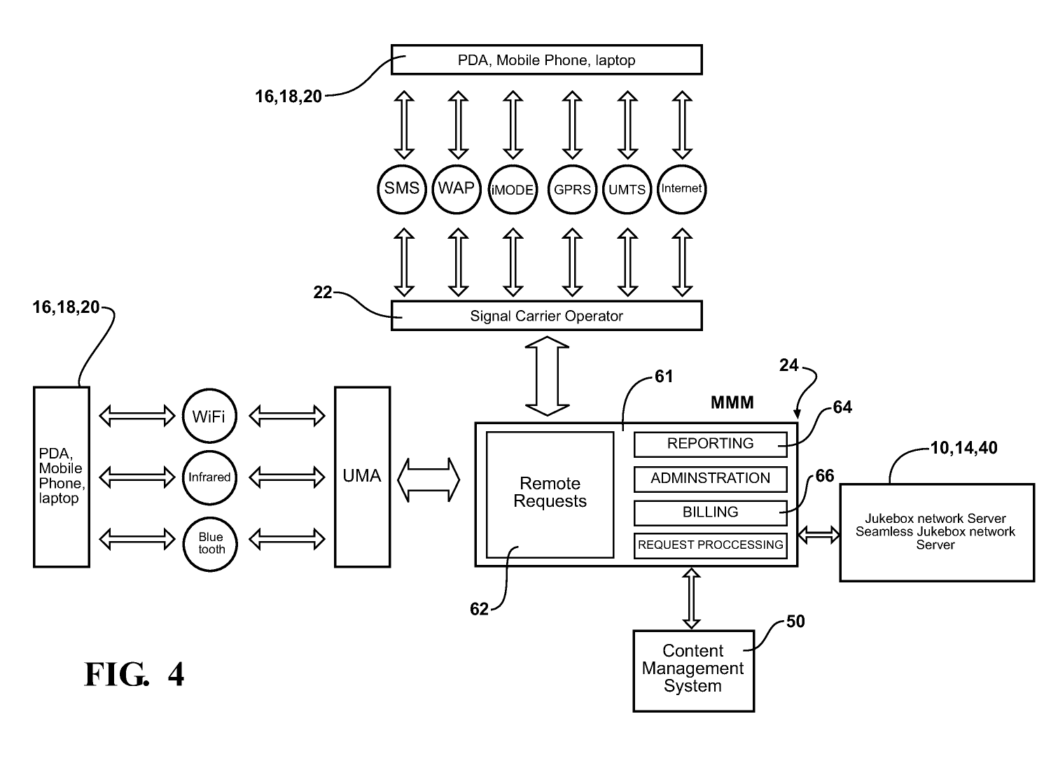

FIGS. 3 and 4 depict block diagrams of the major components of the control means or mobile media manager 24. The MMM 24 includes a so-called m-Venue server 61 which communicates with any of the A/V devices 14 and LMS 140, 142 and 144.

An example of a device or a system that can be used as a basis for implementing the system and functionality described herein on the server 61 is a computing device or computer. The computer can be any suitable computer or computing device. As an example, the computer can include one or more processors, such as a central processing unit (CPU) and memory, such as RAM memory and ROM memory. A storage device can be optionally provided in the form of any suitable computer readable medium, such as a hard disc drive. One or more input devices such as a keyboard and mouse, a touch screen interface, etc., allow input to be provided to the CPU. The display, such as liquid crystal display (LCD) or a cathode-ray tube (CRT) allows output to be presented to the user. A communication that is operable to send and receive data or other signals using the networks 12 or 22. Each user request is also forwarded to a reporting module 64 which is in communication with the m-Venue server 61 to record each user request and the validation of a successful digital selection. The reporting module 64 communicates with a billing module 66 which suggests the fee for each user request. The MMM 24, as described above, can receive a remote content of digital media selection signal from any source. The MMM 24 then checks the selection for validity, processes it, stores it in a database, and forwards the request to the network server 10 in the aspect shown in FIG. 1.

The LMS 140 receives the A/V data or stream from the MMM 24 and tries to the place the request to the specified A/V device 14. If this is successful, the LMS 140 then replies with a success message to the waiting MMM 24. If for any reason there is a failure in the request process, such as the A/V device 14 not responding, the transmission network is down, etc., the LMS 140 replies to the MMM 24 with a failure message along with the reason of the failure. Once the MMM 24 has received an answer to the remote content selection signal, the MMM 24 records the answer in the database and informs the user with the result of his request.

A user request from any of the mobile user interface devices 16, 18, and 20 is communicated through the network 22 to a mobile request control means 62. The user request is then communicated to the m-Venue server 61 for digital content selection at a specific digital audio-visual playback device 14, etc.

Each user request is also forwarded to a reporting module 64 which is in communication with the m-Venue server 61 to record each user request and the validation of a successful digital selection. The reporting module 64 communicates with a billing module 66 which suggests the fee for each user request.

One aspect of an expanded mobile media manager network 100 coupled to multiple A/V devices 14 is in depicted FIG. 1. In the network 100, the MMM 24 is referred to as the primary or master MMM 24. At least one and, for example, a plurality of additional mobile media managers, with three additional mobile media managers 102, 104 and 106, depicted by way of example only in FIG. 1, are coupled in data communication with the master MMM 24. Although any or all of the additional MMMs 102, 104, and 106 may be physical servers, in the same manner as the master MMM 24, in this aspect, the additional MMMs 102, 104, and 106 are virtual MMMs.

The virtual MMMs 102, 104 and 106 are implemented in a computer readable medium or software to perform the same functions as the master MMM 24. The software program is executed by a processor in a server or other computing device. Such processor or computing devices may be part of the master MMM 24 and or in a separate server located in the same physical location or data center as the master MMM 24. Alternately, the computing device or server containing the software program medium implementing each or all of the virtual MMMs 102, 104, and 106 may be physically located separate or remote from the master MMM 24 in a different location or datacenter.

As shown in FIG. 1, and in greater detail in FIG. 2, the MMMs 102, 104, and 106 share communication paths with each other and with the master MMM 24 in the network 110. Communications paths, all denoted by reference number 111, may be any combination of hardware, wireless, etc. The communication paths 111 are arranged in a so-called “mesh”arrangement to allow the master MMM 24 to communicate with each of the virtual MMMs 102, 104, and 106 or to communicate simultaneously with all of the virtual MMS 102, 104 and 106. Each of the virtual MMMs 102, 104, and 106 can also communicate with one or both of the other virtual MMMs. In this manner, each of the MMMs 24, 102, 104 and 106 have access to the digital media content database 50 as well as any other media content stored in a memory associated with any of the MMM's 24, 102, 104 and 106.

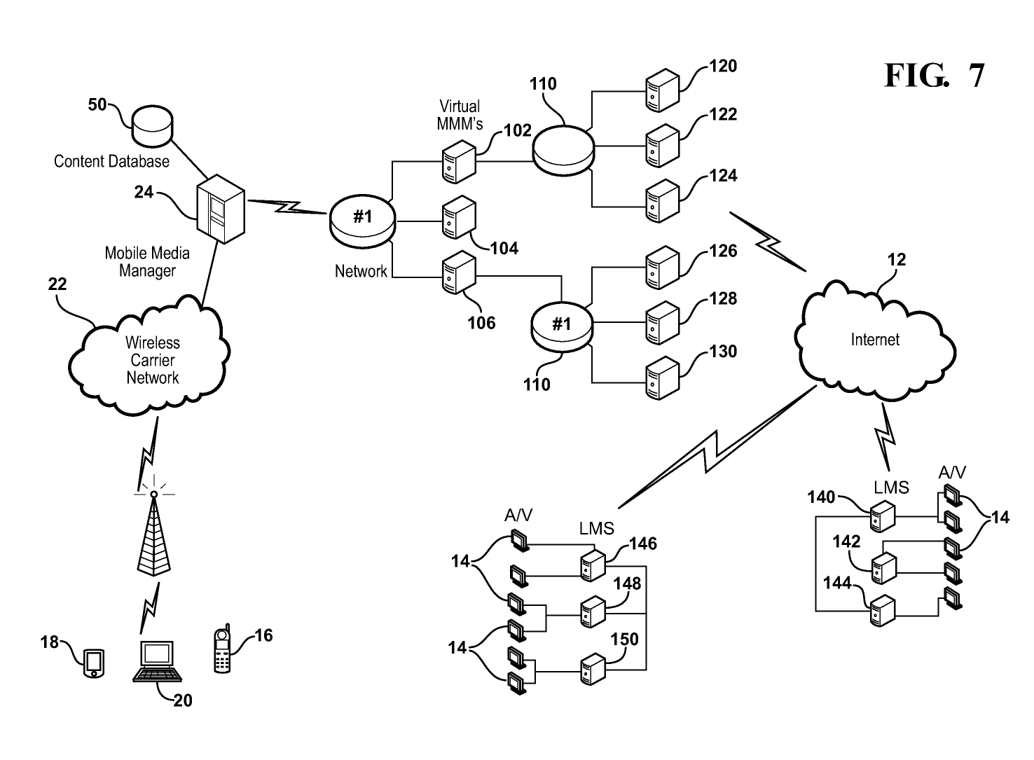

Optionally, as shown in FIG. 7, all or certain ones of virtual MMMs 102, 104, and 106 may communicate, either by a hardware or a wireless communication path or combinations thereof, with one or a plurality of virtual sub-MMM's such as sub MMM's 120, 122, and 124 for the virtual MMM 102. Virtual sub MMMs 126, 128 and 130 maybe coupled in data communication via a network 110 to virtual MMM 106. Although virtual MMM 104 is not depicted as having any sub-virtual MMMs, it will be understood that the virtual MMM 104 could also have one or more sub-virtual MMMs.

It will be understood that although three sub MMM's are illustrated in FIG. 7 for each or some of the virtual MMMs 102, 104 and 106, the sub MMM's may be provided in any number or not at all for any of the virtual MMMs 102, 104 and 106.

The sub MMM's, such MMM 120, 122 and 124, can also be embodied in physical servers or, for example, as virtual MMM's residing in a physical server containing the immediate parent MMM or in the server in the data center containing the master MMM 24, or in completely separate servers in separate locations.

The MMMs 102, 120, 122 and 124, and/the MMMs 106, 126, and 130 may be connected in any hierarchal arrangement, such as a tree, or the indicated mesh/star arrangement 111 shown in FIG. 2, wherein each 102, 120, 122 and 124 are coupled in communication with each other so that all data is accessible by each different mobile media manager.

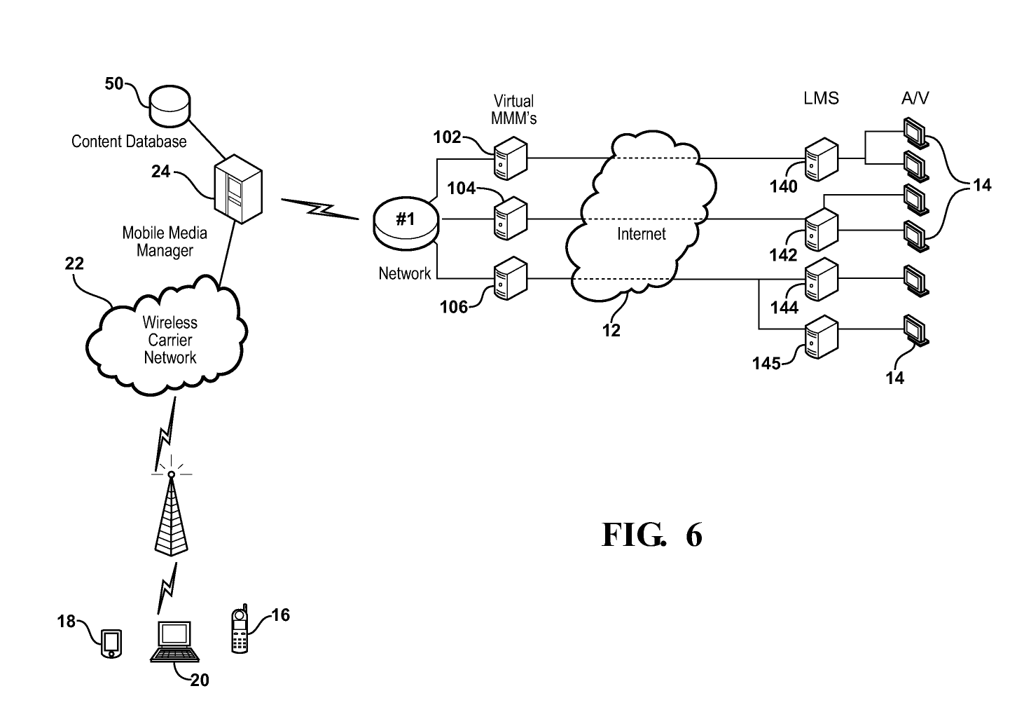

In a tree network, instead of the mesh/star network 111, the virtual sub MMMs 120, 122 and 124 are directly coupled to the corresponding virtual MMM 102, in the same manner as the network connections shown in FIG. 6, and do not include any communication with the other virtual sub MMMs 120, 122 and 124.

Combinations of tree/hierarchal and mesh/star networks may also be used for the virtual sub MMMs 120, 122, 124, and/or 126, 128 and 130.

Referring now to FIG. 6, there is depicted a modification of the interactive content request apparatus shown in FIG. 1. In this aspect, each virtual MMM 102, 104 and 106 can communicate only with a single LMS, such as LMS 140 for virtual MMM 102, LMS 142 for virtual MMM 104 and LMS 144 for virtual MMM 106. It should be noted that, for example, the virtual MMM 106 is illustrated in FIG. 6 as being disposed in data communication with two LMSs 144 and 146.

As described previously, each LMS 140, 142, 144 and 145 may be coupled to one or a plurality of A/V units 14.

This tree or hierarchal network between the virtual MMMs 102, 104 and 106 and the LMSs 140, 142, 144 and 145 is expandable to any number of virtual MMMs and any number of LMSs, with each virtual MMM coupled to one or more LMSs and each LMS coupled to one or more A/V units.

The sub MMMs 120-130 communicate either wirelessly or via hardwire connections or by a combination of both the wireless and hardwire, with an Internet connection 12 illustrated in FIG. 7 by way of example only, to one or more location media server s (LMS), such as LMS's 140 and 142, 144, 146, 148 and 150. One or more LMS servers may be coupled to each sub MMM 120-130.

Further, each LMS 140, 142 and 144, etc., is coupled, either wirelessly, by hardwire or by a combinations thereof, to one or more A/V units 14. For example, the LMS 140 is coupled to two A/V devices 14. The LMS 144 is coupled only to a single A/V device 14, for example only.

The illustrated hierarchal arrangement of MMMs from master to virtual-MMMs and through multiple sub MMMs to multiple A/V devices 14 provides network accessibility for streaming or supplying audio or visual content from the content database 50 to any A/V device 14. Further, the virtual and sub MMM's have the capability to determine which MMM has the resources, available processor time, operating speed etc., to supply a user request of selected media content of content database 50 to a selected A/V device 14.

As also shown in FIG. 1, a streaming audio-video server 60, embodied in the form of a computing device having a processor executing a stored controlled program stored in a memory coupled to the processor, is itself coupled in wireless, hardwire or combinations thereof communication with the master MMM 24, the network 110 between the master MMM 24 and the one or more virtual MMM's 102, 104 and 106, as well as the Internet 12. The streaming audio-video server (SAVS) 60 contains A/V software which converts the digital format of a selected digital media in the content database 50 identified in a user request into a streaming audio-video format. This streaming A/V format can be specific to the particular A/V 14 identified in the user request.

The SAVS 60 is capable, upon receiving a command from the master MMM 24, to retrieve a selected digital media identified in the user request from the content database 50, convert the digital media to streaming A/V format and then transfer the streaming A/V stream either directly through the Internet 12 to the identified LMS 140, 142, or 144 and then to the selected A/V device 14 or to one of the virtual MMMs 102, 104, and 106, which in turn handles the transfer of the digital media to the selected LMS 140, 142, 144 and the specific A/V device 14.

The connection between the SAVS 60 through the network 110 to the virtual MMM's 102, 104 and 106 enables the virtual MMM's 102, 104 and 106 to communicate with and query the SAVS 60 in the same way as the master MMM 24 described above.

The master MMM 24 and the streaming audio-video server 60 can also be combined into a single computing device or server having the combined functionality of both separate devices.

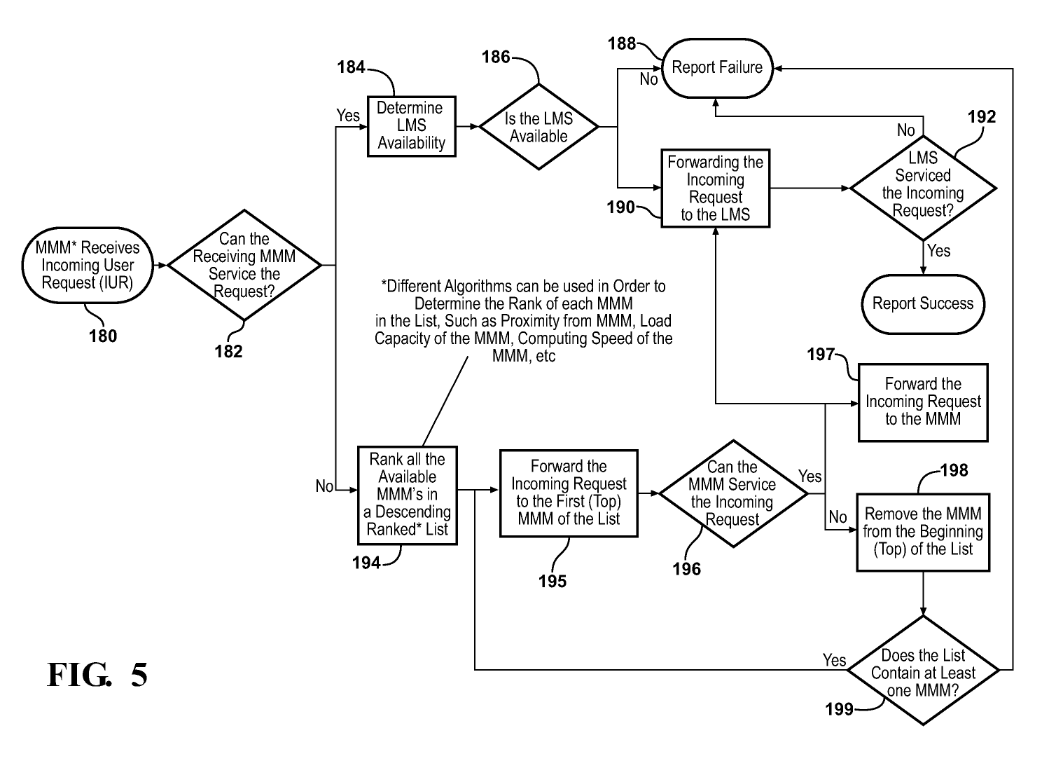

As shown in FIG. 5, the master MMM 24, which can communicate with any of the virtual MMM's 102, 104 and 106, receives an incoming user request in step 180. The master MMM 24 first determines in step 182 whether it can service the user request to supply selected media content to an A/V device 14 specified in the user request.

The master MMM 24 uses various factors to determine if it can service received user request. Such factors can include, for example, but not limited to is the master MMM 24 operating, does the master MMM have the data processing capability to handle in incoming user request at the time of the user request or within a predetermined time period after receiving the user request, etc.

Each sub or virtual MMM 102, 104 and 106 also has the capability to execute the same ranking algorithm used by the master MMM 24, as described above, in the event that the master MMM 24 is not able to service an incoming user request. In this situation, the top most ranked virtual MMM 102, 104 and 106 will perform the functions of the master MMM 24 shown in FIG. 5 and rank the other MMM 102, 104, and 106 in a predetermined order based on the same algorithm factors described above for the master MMM 24, in the event that the top most MMM 102, 104, and 106 is not able to service an incoming user request.

If the receiving MMM 24 can service the user request in step 180, the receiving MMM 24 determines the availability of an LMS. If an LMS, such as LMS 140 or 142 is available, operating and coupled to the specified A/V device 14, the master MMM 24 determines if the LMS 140 or 142, is available to process the user request. In determining if the LMS 140 or 142 is available to process the user request, the master MMM 24 determines if the particular LMS, 140 or 142, is currently in an operative state, whether LMS 140 or 142 has the capability to handle the amount data associated with the user request, can the selected LMS 140 or 142 handle the transfer of the data associated with the user request to the selected A/V device in a timely fashion, or can the LMS 140 or 142, using predetermined rules of play for user request at the location of the selected A/V device, such as parental controls, time of day factors, types of digital content playable at the location of the A/V, etc.

In step 186, if the available LMS is not able to process the user request in step 184, the receiving MMM 24 reports a failure in step 188.

If, however, the LMS is available to process the user request, the receiving MMM 24 forwards the incoming user request to the selected LMS in step 190. The receiving MMM in step 192 then determines if the LMS servicing the incoming request by transmitting selected media content to the selected AV device 14. If the selected LMS did fully service the incoming user request, the receiving MMM 24 reports a successful event and can begin processing an invoice to the user as well as a return completion message, as described above.

Referring now to FIG. 1, there is depicted another aspect of the present digital media selection and play network. In this aspect, a streaming audio-video (A/V) storage database 160 is disposed in data communication with the master media manager controller 24, by either hardwire, wireless communication or a combinations thereof. The streaming A/V storage 160 communicates with the streaming A/V server 60.

This arrangement enables streaming A/V content to be selected by a user, communicated through the MMM 24 via the Internet to the A/V server 162 which selects the desired streaming content and transmits the content through the Internet 12 to a selected LMS which then streams the A/V content through the A/V output of the LMS 140 to the selected A/V device 14.

Referring back to step 182, if the receiving MMM 24 cannot service the request, the MMM 24 ranks all of the available sub MMMs 102, 104, and 106, in a descending rank list according to pre-selected parameters. Different algorithms or parameters can be used to determine the rank of each MMM in such a list, such as proximity from the master MMM 24, the capacity of each MMM, the computer speed of each MMM, current data processing activities, etc.

The MMM 24 then forwards the incoming user request to the first or top most MMM in the ranked list in step 195. The MMM 24 then determines if the first or top selected MMM can service the incoming user request in step 196. The decision is based on whether the selected MMM is operable, whether it has access to the selected media content in the user request, whether the selected MMM is coupled to the selected AV device, etc. If the selected MMM can service the incoming user request, the master MMM 24 forwards the incoming user request to the selected MMM, such as MMM 102 in step 197, which then processes the user request through one LMS in step 190 to the selected AV device 14.

If, however, the selected MMM cannot service or process the incoming user request in step 196, the MMM 24 removes the selected MMM from the first or top descending rank in the list of MMM'S in step 198. If the list contains at least one more MMM as determined in step 199, control returns to step 196. When a negative result from step 199 that there are no more MMMs available to process the user request, a failure reported to the user in the system.

1. A method for media content selection and play comprising the steps of:
receiving, by a master media manager controller, a user request requesting a specific digital media for play on a selected audio-visual playback device;
disposing at least one virtual media manager controller residing in a computer readable medium of a computing device in data communication with the master media manager controller;
disposing at least one location media server in communication with the at least one virtual media manager controller;
disposing at least one audio-visual device in communication with the at least one location media server;
accessing, by the master media manager controller, a store of digital media to locate the digital media in the user request; and
transmitting the located digital media by the master media manager controller through the at least one virtual media manager controller and the at least one location media server to the selected audio-visual device for play of the located digital media by the selected audio-visual device.

2. The method of claim 1 further comprising:
providing a plurality of virtual media manager controllers in communication with the master media manager controller;
providing a plurality of location media servers, at least one location media server disposed in communication with each virtual media manager controller; and
at least one audio-visual device disposed in communication with each location media server.

3. The method of claim 2 further comprising the steps of:
disposing the plurality of virtual media manager controllers and the master media manager controller in communication with each other such that each one of the master media manager controller and the virtual master media manager controllers are able to access the media store.

4. The method of claim 3 further comprising:
coupling the plurality of virtual master media manager controllers and the master media manager controller in a mesh network with each other.

5. The method of claim 3 further comprising:
coupling the plurality of virtual master media manager controllers and the master media manager controller in a hierarchal tree network with each other.

6. The method of claim 2 further comprising the step of:
configuring each of the master media manager controller and the virtual master media manager controllers for receiving a user request.

7. The method of claim 6 further comprising:
determining by the one of the master media manager controller and the one virtual media manager controller that receives a user request if the receiving one of the master media manager controller and the one virtual media manager controller can service the user request;
if yes, determining, by the receiving one of the master media manager controller, and the one virtual media manager controller the availability of one of the location media servers disposed in communication with the receiving one virtual media manager controller; and
if the one location media server is available, forwarding by the receiving one of the master media manager controller and the one virtual media manager controller the digital media in the user request to the selected one location media server.

8. The method of claim 7 further comprising:
if the receiving master media manager controller and the one virtual media manager controller cannot service the incoming user request, the receiving one master media manager controller and, one initial media manager controller ranking all of the available virtual media manager controllers in descending rank according to ranking parameters;
forwarding the incoming user request to a first ranked virtual media manager controller;
determining by the first ranked virtual media manager controller if it can service the incoming user request;
if the first ranked virtual media manager controller can service the request, forwarding, by the receiving one of the master media manager controller, and the one virtual media manager controller the digital media in the incoming user request to the one location media server.

9. The method of claim 8 further comprising:
if the first ranked virtual media manager controller cannot service the incoming user request, removing, by the receiving media manager controller and the one virtual media manager, the first ranked virtual media manager controller as the first ranked virtual media manager controller; and
forwarding the digital media in the the incoming request to the next highest ranked virtual media manager controller.

10. The method of claim 3 further comprising:
coupling a streaming audio-video server in communication with each of the master media manager controller and each of the virtual media manager controllers;
executing, by the streaming audio-video server, a stored controlled program for converting a digital format media to a streaming audio-video signal.

11. The method of claim 10 further comprising:
coupling the streaming audio-video server in communication with the Internet for transferring a streaming audio-video signal to a selected one of the location media servers for play on a selected one audio-video device.

12. An apparatus for media content selection and play comprising:
means for receiving, by a master media manager controller, a user request requesting a specific media for play on a specified audio-visual playback device;
means for disposing at least one virtual media manager controller residing in a computer readable medium of a computing device in data communication with the virtual media manager controller;
means for disposing at least one location media server in communication with the at least one virtual media manager controller;
means for disposing at least one audio-visual device in communication with the at least one location media server;
means for accessing, by the master manager media manager controller, a store of media content to locate the digital media in the user request; and
means for transmitting the located digital media by the master media manager controller through the at least one virtual media manager controller and the at least one location media server to the selected at least one audio-visual device for play of the located digital media by the selected at least one audio-visual device.

13. An apparatus for media content selection and play comprising:
at least one audio-visual playback device capable of playing audio-visual media, the audio-visual playback device having a distinct identifier;
a location media server coupled to the at least one audio-visual playback device for transferring media content to the at least one audio-visual playback device;
a master media manager controller configured for receiving a user request from a user interface separate from the at least one audio-visual playback device and the master media manager controller, the user request identifying a distinct audio-visual media content and the distinct identifier of the at least one digital audio-visual playback device;
at least one virtual media manager controller embodied in a computer executable medium in a computing device coupled to the master media manager controller; and
the at least one virtual media manager controller coupled by a first communication path with the at least one location media server .

14. The apparatus of claim 13 wherein:
the at least one virtual media manager controller includes a plurality of separately operable, virtual media manager controllers.

15. The apparatus of claim 14 further comprising:
a communication network coupling the master media manager controller with each of the plurality of virtual media manager controllers.

16. The apparatus of claim 15 wherein the network comprises:
a mesh communications network coupling each of the master media manager controller and the virtual media manager controllers to each other.

17. The apparatus of claim 15 wherein the network comprises:
a tree network coupling the master media manager controller and the virtual media manager controllers.

18. The apparatus of claim 14 wherein:
the at least one location media server and the at least one digital audio-visual playback device include a plurality of location media servers, each coupled to at least one independent audio-visual playback device, each audio-visual playback device having a distinct identifier.

19. The apparatus of claim 18 further comprising:
each of the virtual media manager controllers coupled via a first communication path to each of the plurality of location media server s servers.

20. The apparatus of claim 18 wherein:
each of the virtual media manager controllers coupled via a first communication path to a separate one of the plurality of location media servers.

21. The apparatus of claim 13 further comprising:
at least one sub virtual media manager controller coupled to the at least one virtual media manager controller; and
the at least one sub virtual media manager controller coupled by the first communication path to one of the plurality of location media servers.

22. The apparatus of claim 21 wherein:
the at least one virtual media manager controller comprises a plurality of virtual media manager controllers; and
at least one of the plurality of virtual media manager controllers coupled to at least one sub virtual media manager controller.

23. The apparatus of claim 14 further comprising:
a streaming audio-video server coupled in communication with the master media manager controller and each of the virtual media manager controllers;
the streaming audio-video server executing a stored control program for converting a digital format media to a streaming audio-video signal.

24. The apparatus of claim 23 further comprising:
the streaming audio-video server coupled in communication with the Internet for transferring a streaming audio-video signal to a selected one of the location media servers for play on a selected audio-video device.
